(19) United States
(12) Patent Application Publication
(10) Pub. No.: US 2016/0139647 A1
(43) Pub. Date: May 19, 2016

(54) APPARATUS AND METHOD FOR AUTOMATICALLY CONTROLLING POWER SAVING FUNCTION OF COMPUTER AND MONITOR

(71) Applicant: ELECTRONICS AND TELECOMMUNICATIONS RESEARCH INSTITUTE, Daejeon (KR)

(72) Inventor: Moon-Ok CHOI, Cheongju-Si (KR)

(73) Assignee: ELECTRONICS AND TELECOMMUNICATIONS RESEARCH INSTITUTE, Daejeon (KR)

(21) Appl. No.: 14/843,993

(22) Filed: Sep. 2, 2015

(30) Foreign Application Priority Data
Nov. 14, 2014 (KR) 10-2014-0158529

(51) Int. Cl. G06F 1/32

(52) U.S. Cl. CPC G06F 1/3231

(57) ABSTRACT

An apparatus and method for automatically controlling the power saving function of a computer and a monitor are disclosed herein. The apparatus for automatically controlling the power saving function of a computer and a monitor includes a distance calculation unit, an entry or exit determination unit, and a power saving control unit. The distance calculation unit calculates the distances between two or more beacon devices and a terminal of a user. The entry or exit determination unit determines the entry or exit state of the user by checking a change in a first distance between the terminal and a gate beacon device. The power saving control unit controls the power saving function of the computer and monitor of the user by considering one or more of the entry or exit state and a second distance between the terminal and a user beacon device closest to the computer of the user.

### CROSS-REFERENCE TO RELATED APPLICATION

This application claims the benefit of Korean Patent Application No. 10-2014-0158529, filed Nov. 14, 2014, which is hereby incorporated by reference herein in its entirety.

### BACKGROUND

1. Technical Field

Embodiments of the present invention relate generally to the automatic control of the power saving function of a computer and a monitor and, more particularly, to technology for automatically controlling the power saving function of a computer and a monitor, which is capable of controlling the power saving function of a computer and a monitor by detecting the movement of a user who carries a terminal and measuring information about the location of the user at specific periods.

2. Description of the Related Art

Energy consumption has continued to increase around the world, and thus energy expenses have continued to increase. As the development and spread of information technology (IT) applications increase, an increase in the portion of power energy consumed by, in particular, IT devices in the field of power energy becomes apparent. Meanwhile, when the field of energy consumption is divided into industry, building, and transportation fields, an increase in the use of building energy overtakes other fields. Accordingly, research is being carried out on technology for saving energy, consumed in the building field, in various ways.

In energy consumed in the building field, most power in a common office environment is chiefly consumed by IT devices, such as computers, monitors, printers and copy machines, and lighting devices. Among them, the computers are commonly equipped with a power saving function at a hardware or operating system level. Users can set and manage details of power saving functions for computers, monitors and hard disks using operating systems. However, in a common office environment, it is difficult to set and use such a power saving function in terms of convenience, and thus the utilization of the power saving function is not sufficient. In general, recent computers support the Advanced Configuration and Power Interface (ACPI), which is a device configuration and power management standard. Accordingly, after a lapse of a specific period in which there has been no usage input, computers can automatically switch to power saving mode (S1, S2, S3, or S4 in the ACPI standard) or the screen brightness control or power-off state of a monitor. In order for the computers to return from power saving mode to a working state (i.e., state S0 in the ACPI standard), a period ranging from several seconds to tens of seconds is required depending on the power saving mode defined in the ACPI standard. In this case, the higher the level of the power saving mode is, the longer the period it takes to return to its working state is. Accordingly, in a common office environment in which empty seats, attributable to meetings, meals and rest, and rapid computer task return situations frequently occur, inconvenience may be caused by the periods required for return to computer tasks in the use of the existing power saving functions supported by computers and operating systems. As a result, the utilization of the power saving functions of users is reduced, and thus it is difficult to achieve effective power conservation.

In general, conventional technologies for managing the power consumption of a computer in an office environment adopt solutions using the monitoring and reporting of the power consumption, usage fees and carbon emission quantities of IT devices, such as a computer and a monitor, and the control of power saving based on policies, set by an administrator or user, as their common major functions. However, these conventional technologies do not provide an appropriate solution to a user convenience issue related to the period it takes for the computer to return to its working state.

Furthermore, a conventional technology has been disclosed in which a separate sensor information reception device capable of recognizing Radio Frequency Identification (RFID) tags and integrated circuit (IC) cards is connected to a computer via a wired/wireless connection and the power saving mode of the computer is controlled by detecting the use of the computer based on a sensor recognition action of a user. However, this approach is also limited in terms of convenience, required to increase the utilization of a user, due to the period it takes for the computer to return to its working state, as well as the sensor recognition action of the user.

### RELATED ART DOCUMENT

### Patent Document

(Patent Document 1) Korean Patent Application Publication No. 10-2012-0075938 (published on Jul. 9, 2012) entitled “Apparatus for Saving Power of LCD Monitor with Distance Sensor and Method of Saving Power of LCD Monitor Using Same.”

### SUMMARY

At least one embodiment of the present invention is directed to the provision of a method of detecting the location of a user in an office environment or the distance between the user and a computer of the user and automatically controlling the entry and return of the computer to and from power saving mode and the power on and off states of a monitor using the detected location or signal intensity information and information about an expected period it takes for the user computer to return to its working state.

At least one embodiment of the present invention is directed to the provision of a method of automatically conserving the power of a computer and a monitor having improved user convenience, which is capable of increasing the utilization of a power saving function and thus saving power consumed as building energy.

In accordance with an aspect of the present invention, there is provided an apparatus for automatically controlling the power saving function of a computer and a monitor, the apparatus including: a distance calculation unit configured to calculate the distances between two or more beacon devices, installed within a building, and a terminal of a user; an entry or exit determination unit configured to determine the entry or exit state of the user by checking a change in a first distance that belongs to the distances and that is the distance between the terminal and a gate beacon device that belongs to the two or more beacon devices and that is installed at a gate; and a power saving control unit configured to control the power saving function of the computer and monitor of the user by considering one or more of the entry or exit state and a second distance that belongs to the distances and that is the distance between the terminal and a user beacon device that belongs to the two or more beacon devices and that is closest to the computer of the user.

The distance calculation unit may check the moving direction of the terminal based on any one of the gate beacon device and the user beacon device, and may calculate each of the first distance and the second distance by applying an error compensation distance to the approximate distance between any one of the beacon devices and the terminal according to the moving direction.

The distance calculation unit may calculate the approximate distance using signal intensity information included in beacon signals transmitted by the two or more beacon devices at predetermined periods, may calculate the approximate distance at the predetermined periods, and may check the moving direction.

The distance calculation unit may obtain the signal intensity information used to calculate the first distance and the second distance by identifying a gate beacon ID that belongs to beacon IDs, which are included in the beacon signals along with the signal intensity information and which correspond to the two or more beacon devices, and that corresponds to the gate beacon device and a user beacon ID that belongs to the beacon IDs and that corresponds to the user beacon device.

The entry or exit determination unit may search for a beacon device that belongs to the two or more beacon devices and that is closest to the terminal by comparing the distances, and may determine the entry or exit state by considering one or more of whether the closest beacon device has been updated and the change in the first distance if the closest beacon device is the gate beacon device.

The entry or exit determination unit may determine the entry or exit state to be an exit state if the first distance calculated at the predetermined period has gradually increased and the closest beacon device has not been updated in the gate beacon device.

The power saving control unit may apply the power saving function of the monitor if the second distance is equal to or longer than a predetermined limit distance, and may apply the power saving function of the computer if the entry or exit state is an exit state and the first distance is equal to or longer than a predetermined external limit distance.

The power saving control unit may control the power saving function of the monitor by comparing the second distance with the predetermined limit distance at the predetermined periods.

The power saving control unit may set the predetermined limit distance and the predetermined external limit distance by considering one or more of the average moving speed of the user and the period it takes for the power saving function of the computer and the monitor to be released.

The power saving control unit may release the power saving function of the monitor when the power saving control unit releases the power saving function of the computer.

In accordance with another aspect of the present invention, there is provided a method of automatically controlling the power saving function of a computer and a monitor, the method including: calculating the distances between two or more beacon devices, installed within a building, and a terminal of a user; determining the entry or exit state of the user by checking a change in a first distance that belongs to the distances and that is the distance between the terminal and a gate beacon device that belongs to the two or more beacon devices and that is installed at a gate; and controlling the power saving function of the computer and monitor of the user by considering one or more of the entry or exit state and a second distance that belongs to the distances and that is the distance between the terminal and a user beacon device that belongs to the two or more beacon devices and that is closest to the computer of the user.

Calculating the distances may include: checking the moving direction of the terminal based on any one of the gate beacon device and the user beacon device; and calculating each of the first distance and the second distance by applying an error compensation distance to the approximate distance between any one of the beacon devices and the terminal according to the moving direction.

Calculating the distances may include: calculating the approximate distance using signal intensity information included in beacon signals transmitted by the two or more beacon devices at predetermined periods; calculating the approximate distance at the predetermined periods; and checking the moving direction.

Calculating the distances may include obtaining the signal intensity information used to calculate the first distance and the second distance by identifying a gate beacon ID that belongs to beacon IDs, which are included in the beacon signals along with the signal intensity information and which correspond to the two or more beacon devices, and that corresponds to the gate beacon device and a user beacon ID that belongs to the beacon IDs and that corresponds to the user beacon device.

Determining the entry or exit state may include searching for a beacon device that belongs to the two or more beacon devices and that is closest to the terminal by comparing the distances; and the entry or exit state may be determined by considering one or more of whether the closest beacon device has been updated and the change in the first distance if the closest beacon device is the gate beacon device.

Determining the entry or exit state may include determining the entry or exit state to be an exit state if the first distance calculated at the predetermined periods has gradually increased and the closest beacon device has not been updated in the gate beacon device.

Controlling the power saving function may include: applying the power saving function of the monitor if the second distance is equal to or longer than a predetermined limit distance; and applying the power saving function of the computer if the entry or exit state is an exit state and the first distance is equal to or longer than a predetermined external limit distance.

Controlling the power saving function may include controlling the power saving function of the monitor by comparing the second distance with the predetermined limit distance at the predetermined periods.

Controlling the power saving function may include setting the predetermined limit distance and the predetermined external limit distance by considering one or more of an average moving speed of the user and the period it takes for the power saving function of the computer and monitor to be released.

Controlling the power saving function may include releasing the power saving function of the monitor when the power saving control unit releases the power saving function of the computer.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating a system for automatically controlling the power saving function of a computer and a monitor according to an embodiment of the present invention;

FIG. 2 is a block diagram of the apparatus for automatically controlling the power saving function of a computer and a monitor illustrated in FIG. 1;

FIG. 3 is a diagram illustrating an example in which beacon devices are installed in an office environment according to an embodiment of the present invention;

FIG. 4 is an operation flowchart illustrating a method of automatically controlling the power saving function of a computer and a monitor according to an embodiment of the present invention;

FIG. 5 is an operation flowchart illustrating a process of controlling the power saving function of a monitor according to an embodiment of the present invention; and

FIG. 6 is an operation flowchart illustrating a process of controlling the power saving function of a computer according to an embodiment of the present invention.

### DETAILED DESCRIPTION

Embodiments of the present invention will be described in detail below with reference to the accompanying drawings. Redundant descriptions and descriptions of well-known functions and configurations that have been deemed to make the gist of the present invention unnecessarily obscure will be omitted below. The embodiments of the present invention are intended to fully describe the present invention to persons having ordinary knowledge in the art to which the present invention pertains. Accordingly, the shapes, sizes, etc. of components in the drawings may be exaggerated to make the description obvious.

Embodiments of the present invention are described in detail below with reference to the accompanying drawings.

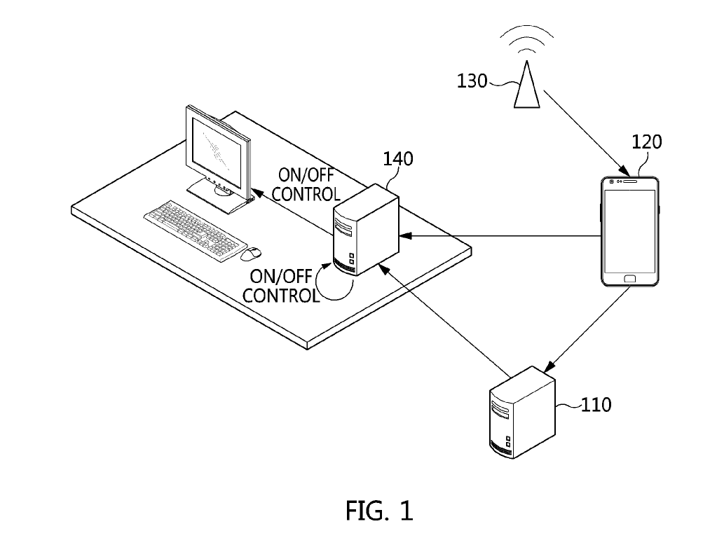

FIG. 1 is a diagram illustrating a system for automatically controlling the power saving function of a computer and a monitor according to an embodiment of the present invention.

Referring to FIG. 1, the system for automatically controlling the power saving function of a computer and a monitor according to the present embodiment includes an apparatus 110 for automatically controlling the power saving function of a computer and a monitor, a terminal 120 of a user, one or more beacon devices 130 installed inside or outside a building, and a computer 140 of the user.

The apparatus 110 for automatically controlling the power saving function of a computer and a monitor calculates the distances between two or more beacon devices 130 installed inside a building and the terminal 120 of the user. For example, at least two beacon devices 130 may be installed such that one beacon device 130 is installed in an office and the other beacon device 130 is installed at the gate of the office.

In this case, the moving direction of the terminal 120 may be checked based on a gate beacon device installed at the gate of the office or a user beacon device located closest to the computer 140 of the user. A first distance between the gate beacon device and the terminal 120 and a second distance between the user beacon device and the terminal 120 may be calculated by applying error compensation distances to approximate distances between the beacon devices 130 and the terminal 120 according to the moving direction.

In this case, the approximate distances between the beacon devices 130 and the terminal 120 may be calculated using signal intensity information included in beacon signals transmitted by the two or more beacon devices 130 at predetermined periods, and the moving direction of the terminal 120 of the user may be checked by calculating the approximate distances at predetermined periods.

In this case, the signal intensity information used to calculate the first distance and the second distance may be obtained by identifying a gate beacon ID and a user beacon ID from beacon IDs that are included in the beacon signals along with the signal intensity information and that correspond to the two or more beacon devices 130.

Furthermore, the apparatus 110 for automatically controlling the power saving function of a computer and a monitor checks a change in the first distance, which belongs to the distances between the two or more beacon devices 130 and the terminal 120 and which is the distance between the gate beacon device and the terminal 120, and the entry or exit state of the terminal 120, i.e., a user who carries the terminal 120.

In this case, a beacon device that belongs to the two or more beacon devices 130 and that is closest to the terminal 120 may be searched for by the comparison of the distances between the two or more beacon devices 130 and the terminal 120. When the closest beacon device is the gate beacon device, the entry or exit state of the user may be determined by considering one or more of whether the closest beacon device has been updated and a change in the first distance between the gate beacon device and the terminal 120.

In this case, if the first distance calculated at predetermined periods has gradually increased and the closest beacon device has not been updated in the gate beacon device, the entry or exit state of the user may be determined to be an exit state.

Furthermore, the apparatus 110 for automatically controlling the power saving function of a computer and a monitor controls the power saving function of the computer and monitor of the user by considering one or more of the second distance, which belongs to the distances between the two or more beacon devices 130 and the terminal 120 and which is the distance between a user beacon device and the terminal 120, and the entry or exit state of the user.

In this case, if the second distance between the user beacon device and the terminal 120 is equal to or longer than a predetermined limit distance, the power saving function of the monitor of the user may be applied. If the entry or exit state of the terminal 120 of the user is an exit state and the first distance between the gate beacon device and the terminal 120 is equal to or longer than a predetermined external limit distance, the power saving function of the computer of the user may be applied.

In this case, the second distance may be compared with the predetermined limit distance at predetermined periods, and the power saving function of the monitor may be controlled based on the result of the comparison.

In this case, the predetermined limit distance and the predetermined external limit distance may be set by considering one or more of the power saving release times of the computer and the monitor and the average moving speed of the user.

In this case, when the power saving function of the computer is released, the power saving function of the monitor may also be released.

The terminal 120 may support a Bluetooth low energy (BLE)-based communication means, may receive a beacon signal broadcast by the beacon device 130, and may provide the beacon signal to the apparatus 110 for automatically controlling the power saving function of a computer and a monitor. In this case, the terminal 120 may perform a process of automatically saving the power of the computer and the monitor via application software installed in the terminal 120.

The terminal 120 is a terminal supporting a BLE-based communication means. The terminal 120 is not limited to a mobile communication terminal, but may include various terminals, such as all types of information communication devices, a multimedia terminal, a wired terminal, a fixed terminal, and an Internet protocol (IP) terminal. Furthermore, the terminal 120 may include mobile terminals having various mobile communication specifications, such as a mobile phone, a portable multimedia player (PMP), a mobile Internet device (MID), a smart phone, a desktop computer, a tablet computer (PC), a note book computer, a net book computer, a personal digital assistant (PDA), a smart TV, and an information communication device.

Two or more beacon devices 130 may be installed in an office environment in order to detect the entry and exit of the terminal 120 to and from the office space or the location of the user in the office environment. The two or more beacon devices 130 may be configured to broadcast beacon signals, each including ID information unique to each device and signal intensity information based on which the distance between the beacon device 130 and the terminal 120 may be calculated as an approximate value, at specific periods. A BLE-based beacon device may be fixed at a specific location in an office environment, i.e., a building. Information about the user beacon ID of the user beacon device that is closest to a computer used by a user may be stored and managed in a mobile application, computer agent program, or separate server. Furthermore, information about the gate beacon ID of the gate beacon device installed at the gate may also be stored and managed in the same way as information about the user beacon ID.

The computer 140 of the user may collectively refer to a computer body and a monitor. An agent software installed on the computer 140 of the user may receive a request for the power saving mode control of the monitor and the computer from any one of the apparatus 110 for automatically controlling the power saving function of a computer and a monitor and the mobile application of the user, and may control the power saving function of the computer and the monitor. For example, if a monitor power-on or power-off request message is received from any one of the apparatus 110 for automatically controlling the power saving function of a computer and a monitor and the mobile application of the user, on or off control may be performed on the power of the monitor included in the computer 140 of the user. Furthermore, a computer body may switch to power saving mode in response to a power saving mode entry request message.

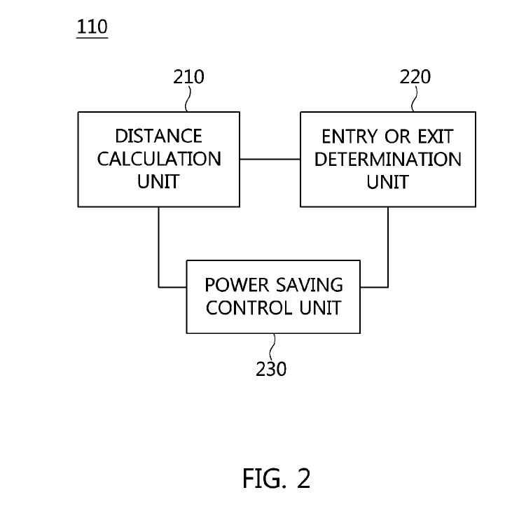

FIG. 2 is a block diagram of the apparatus for automatically controlling the power saving function of a computer and a monitor illustrated in FIG. 1.

Referring to FIG. 2, the apparatus 110 for automatically controlling the power saving function of a computer and a monitor illustrated in FIG. 1 includes a distance calculation unit 210, an entry or exit determination unit 220, and a power saving control unit 230.

The distance calculation unit 210 calculates the distances between two or more beacon devices of a building and a terminal of a user.

Conventional technologies that may be used to obtain information about the location of a specific user in the interior of a room that GPS signals used to check outdoor location information rarely reach include a technology using an RFID, a technology using Wi-Fi, and a technology using Bluetooth.

The RFID technology has different characteristics, operation methods, and application fields depending on frequency band, such as a low frequency (125 kHz, or 134 kHz) band, a high frequency (13.56 MHz) band, an ultrahigh frequency (433.92 MHz, 860˜960 MHz) band, or a microwave (2.54 MHz) band. If the characteristics, the operation methods, costs, and user convenience are taken into account, the high frequency (13.56 MHz) band and the ultrahigh frequency (860˜960 MHz) band may be used to recognize the location of a person in an office environment. In general, the high frequency (13.56 MHz) band has been commonly applied to the detection of the entry and exit of a person to and from a building, and has an approximate detection distance ranging from about 10 cm to 1 m, although there is a slight difference attributable to an RFID reader, an antenna size, or an obstacle. In this case, the entry and exit of a user is detected when the user directly tags a personal access control card having an RFID tag embedded therein to an RFID reader. A method of disposing an RFID reader at a specific location in an office environment and checking the location of a user in response to the tagging action of the user may be used. However, there may be a big problem in that a user must directly tag his or her personal access control card whenever he or she moves his or her location in an office or enters or exits to and from the office in terms of user convenience. In contrast, the ultrahigh frequency (860˜960 MHz) band technology has a detection distance of about 10 m, and thus a plurality of tags included in the detection distance can be recognized at fast speed even when a user does not directly tag his or her personal access control card. However, the ultrahigh frequency technology is problematic in that it requires more costs for installing an RFID reader and an antenna than the high frequency band technology and it has a high erroneous recognition (miss reading or stray reading) probability attributable to the human body, moisture and metal due to the characteristics of the frequency band.

Wi-Fi has been commercialized based on the IEEE standards 802.11a, 802.11g and 802.11n, and commonly has an indoor signal arrival distance of a few tens of meters, although there is a difference in the standards. An indoor location awareness technology using Wi-Fi has been developed under the name of a Wi-Fi positioning system. In this technology, a plurality of wireless access point (AP) map databases is constructed, and a current location is determined by comparing information about an AP connectable to a mobile device of a user supporting Wi-Fi with previously constructed database information. A currently commercialized Wi-Fi technology has an error range of 5 m or more indoors. Wi-Fi has a problem in that it is difficult to apply to a common office environment because a lot of wireless AP information has to be accumulated in a map database in order to reduce location detection errors.

Bluetooth is a short distance wireless communication technology for connecting mobile terminals or surrounding devices over a short distance and wirelessly exchanging data. Most recent common mobile terminals adopt the Bluetooth technology. Recently, the Bluetooth 4.0 standard includes Bluetooth low energy (BLE) (also called Bluetooth smart). BLE consumes a very smaller amount of power than the conventional Bluetooth technology, and it is expected that BLE will be widely used in the fields of healthcare, fitness, security, and home entertainment. Apple Inc. has released iBeacon, i.e., a trademark related to an indoor location awareness technology based on a BLE technology, which is a technology related to an indoor positioning system (IPS), in 2013. In accordance with the technology, an iOS-based device or BLE-based beacon device to which the iBeacon technology has been applied broadcasts unique ID information set in the corresponding device or beacon device in accordance with the BLE standard. A specific app installed in a proximate iOS-based or Android-based mobile device may receive broadcast ID information, and may perform a specific function related to the ID information. Furthermore, the received ID information includes signal intensity information based on which the distance between the mobile device and a BLE-based beacon device can be calculated as an approximate value. Accordingly, a distance ranging from several centimeters to tens of meters may be detected.

Accordingly, among these indoor location awareness technologies, the indoor location awareness technology using a BLE-based beacon device has advantages in terms of installation and maintenance costs, an awareness distance and error, and user convenience attributable to the use of a personal mobile phone over other technologies when a common office environment is taken into account.

A plurality of beacon devices may be installed indoors so that the radio signal range of the BLE-based beacon devices can cover the overall area of a building or office. Furthermore, in order to detect the entry and exit of a user, a beacon device may also be installed at the gate of the building or office. For example, at least two beacon devices may be installed, for example, one in an office and the other at the gate of the office.

In this case, the moving direction of the terminal may be checked based on any one of a gate beacon device that belongs to the two or more beacon devices and that has been installed at the gate of the office and a user beacon device that is closest to the computer of a user. A first distance between the gate beacon device and the terminal and a second distance between the user beacon device and the terminal may each be calculated by applying an error compensation distance to an approximate distance between any one beacon device and the terminal according to the moving direction. In this case, the moving direction may be classified as the direction in which the terminal becomes distant from a beacon device set as a reference, or as the direction in which the terminal becomes close to the beacon device. The distances between the beacon devices and the terminal may each be calculated by adding the error compensation distance to the approximate distance or subtracting the error compensation distance from the approximate distance according to the moving direction. For example, in the case of the direction in which the terminal becomes distant from a user beacon device, the second distance may be calculated by subtracting an error compensation distance from an approximate distance between the user beacon device and the terminal. In the case of the direction in which the terminal becomes close to a user beacon device, the second distance may be calculated by adding an error compensation distance to an approximate distance between the user beacon device and the terminal. As described above, an error compensation distance may be added or subtracted according to the moving direction in order to check the location of the terminal more accurately. Accordingly, convenience when a user uses a power saving system can be improved.

The error compensation distance may be set by a user or system developer, and may be freely modified by a user or system developer after the error compensation distance has been set.

In this case, the approximate distance may be calculated using signal intensity information included in beacon signals transmitted by the two or more beacon devices at predetermined periods, and the moving direction may be checked by calculating the approximate distance at predetermined periods. For example, when the moving direction of the terminal is checked based on a user beacon device, a current approximate distance between the user beacon device and the terminal may be compared with an approximate distance between the user beacon device and the terminal that was calculated at a previous period. If the current approximate distance is longer than the approximate distance, the moving direction of a user may be determined to be the direction in which the terminal becomes distant from the computer of the user. Furthermore, if the current approximate distance is shorter than the approximate distance calculated at a previous period, the moving direction of the user may be determined to be the direction in which the terminal becomes close to the computer of the user. Furthermore, although the reference of the moving direction has been illustrated as being a user beacon device, the moving direction may be determined based on the computer of a user that is located at short distance from a user beacon device according to an object that is fundamental to an invention in which the power saving function of a computer and a monitor is controlled.

Using the above-described method, the moving direction may be classified as the direction in which the terminal moves out of an office or as the direction in which the terminal moves into the office by determining the moving direction of a corresponding user based on the gate beacon device. The first distance may be calculated by adding or subtracting an error compensation distance to or from an approximate distance between the gate beacon device and the terminal according to the moving direction.

Furthermore, the signal intensity information may be information based on which the distances between the two or more beacon devices and the terminal that receives beacon signals may be calculated as approximate values. A distance ranging from several centimeters to tens of meters may be detected using the intensity of the beacon signals.

In this case, the signal intensity information used to calculate the first distance and the second distance may be obtained by identifying a gate beacon ID that belongs to beacon IDs, which are included in the beacon signals along with the signal intensity information and which correspond to the two or more beacon devices, and that corresponds to the gate beacon device and a user beacon ID that belongs to beacon IDs, which are included in the beacon signals along with the signal intensity information and which correspond to the two or more beacon devices, and that corresponds to the user beacon device. For example, the terminal of a user may receive several beacon signals because the two or more beacon devices broadcast the beacon signals at specific periods. The first distance and the second distance may be calculated using signal intensity information included in the beacon signals only when the beacon signals broadcast by the gate beacon device and the user beacon device need to be distinguished from each other. In this case, the beacon signals may be distinguished using beacon IDs included in the respective beacon signals. Accordingly, ID information corresponding to a specific one, such as a user beacon device or gate beacon device, of two or more beacon devices may be previously stored in a server or terminal.

The entry or exit determination unit 220 determines the entry or exit state of a user by checking a change in the first distance that belongs to the distances between the two or more beacon devices and the terminal of the user and that is the distance between the terminal and a gate beacon device. For example, whether a user is located inside or outside a building may be checked based on a gate beacon device. Furthermore, if the user is located outside the building, whether the user moves in order to enter the building may be checked.

In this case, a beacon device that belongs to the two or more beacon devices and that is closest to the terminal may be searched for by comparing the distances between the two or more beacon devices and the terminal of the user. If the beacon device that is closest to the terminal is the gate beacon device, the entry or exit state of the user may be determined by considering one or more of whether the closest beacon device has been updated and a change in the first distance. Since the user has to pass through the gate in order to move outside the building or office, the gate beacon device may be the beacon device that is closest to the terminal of the user at the moment when the user passes through the gate. Accordingly, the time at which the user passes through the gate, i.e., the time at which the beacon device that is closest to the terminal of the user is the gate beacon device, may be detected, and the entry or exit state of the terminal may be checked by checking the moving direction of the user from the detected time.

In this case, if the first distance calculated at predetermined periods has gradually increased and the closest beacon device has not been updated in the gate beacon device, the entry or exit state of the user may be determined to be an exit state. For example, if a beacon device that is closest to the terminal of a user is detected as a gate beacon device, a first distance between the terminal and the gate beacon device may be checked at predetermined periods. In this case, if the first distance had continued to increase but the gate beacon device has not been updated in the beacon device that is closest to the terminal, the entry or exit state of the user may be determined to be the exit state in which the user has passed through the gate and has moved outdoors. Furthermore, if the first distance has continued to increase and a beacon device that is closest to the terminal has been updated with another beacon device installed indoors, the user may be determined to have passed through the gate and moved indoors or to have moved in an indoor direction near the gate.

The power saving control unit 230 controls the power saving function of the computer and monitor of a user by considering one or more of the entry or exit state of the user and a second distance that belongs to the distances between the two or more beacon devices and the terminal of the user and that is the distance between the terminal and a user beacon device that belongs to the two or more beacon devices and that is closest to the computer of the user. The power saving function of the computer and monitor is performed by, for example, the steps of monitor brightness control, monitor power on/off, and computer power saving mode. If the power saving function of the monitor is to be performed, the power saving states of the computer and monitor may be checked first, and then power saving control may be performed. Furthermore, after the computer and the monitor have been run in power saving mode, the power states of the computer and monitor may be checked and managed at specific periods.

Furthermore, the control of the power saving function of the computer and monitor may be performed in such a manner that a power control request message is sent to agent software installed on the computer of the user via applications installed on the apparatus 110 for automatically controlling the power saving function of a computer and a monitor and on the terminal and then the agent software that has received the request message controls the power saving function of the computer and monitor of the user. In this case, in order to enter the power saving mode of the computer and monitor, the apparatus for automatically the power saving function of a controlling a computer and monitor and the applications may control the power saving function of the computer and the monitor in accordance with a wake-on-LAN (WOL) method using wireless communication, such as Wi-Fi, 3G, or 4G communication. In accordance with the WOL method, a computer in power saving mode may be woken up by sending a specific packet to the computer connected to the same local area network (LAN).

In this case, if the second distance between the gate beacon device and the terminal is equal to or longer than a predetermined limit distance, the power saving function of the monitor may be performed. If the entry or exit state of a user is an exit state and the first distance between the user beacon device and the terminal is equal to or longer than a predetermined external limit distance, the power saving function of the computer may be performed. For example, the limit distance and the external limit distance may be set by a user or the apparatus 110 for automatically controlling the power saving function of a computer and a monitor. If a user becomes distant above the limit distance and the external limit distance, the power saving function of the monitor and computer may be performed. Furthermore, when the computer and the monitor are in power saving state, the user who enters within the limit distance and the external limit distance may be detected, and then power saving may be released before the user reaches the computer.

In this case, the power saving function of the monitor may be controlled by comparing the second distance with the predetermined limit distance at predetermined periods. Whenever the beacon signals broadcast by the two or more beacon devices at predetermined periods are received by the terminal, the second distance between the user beacon device and the terminal may be calculated. Accordingly, the location of the user and whether the user has moved may be checked by comparing the second distance with the limit distance at predetermined periods, and then the power saving function of the monitor may be controlled.

Furthermore, the predetermined periods may be set by a user or a system developer. In this case, if the predetermined periods are set to be short, a system load may be increased. If the predetermined periods are set to be long, the efficiency of a power saving system may be lowered. Accordingly, a criterion for setting appropriate periods when a user set periods may be proposed by setting up a maximum period that is the longest period that can be set and a minimum period that is the shortest period that can be set.

In this case, the predetermined limit distance and the predetermined external limit distance may be set by considering one or more of the time at which the power saving function of the computer and monitor is released and average moving speed of the user. For example, the predetermined limit distance and the predetermined external limit distance may be set by calculating the distance in which the user can move during a period from the time at which the computer is released from power saving mode to the time at which the computer returns to a normal state using the average moving speed of the user. Furthermore, if the return period is various because the stepwise power saving modes of the computer and monitor are present, a personal power saving system may be provided to each user by differently setting the limit distance and the external limit distance depending on the type of power saving mode.

Furthermore, the average moving speed of a user may be calculated for each user based on the approximate distance calculated using the beacon signals received by the terminal at predetermined periods. For example, if the first distance between the user beacon device and the terminal changes at predetermined periods, it may be determined that a user is moving. The moving speed of the user may be calculated by calculating the period corresponding to the predetermined period and a change in the first distance that occurs at the predetermined periods.

In this case, when the power saving function of the computer is released, the power saving function of the monitor may also be released. For example, when both the computer and the monitor are in power saving state, the power saving function of the computer may be released when the user moves in the direction of the computer, and then the power saving function of the monitor may be released. However, when the computer and the monitor are sequentially released from power saving mode as described above, a system load may increase because an unnecessary operation is performed when the power saving function of the monitor is released. Accordingly, the power saving function of the computer and the power saving function of the monitor may be simultaneously released. If a user moves in the direction of the computer of the user and does not move in the area in which the power saving function of the monitor needs to be performed, the second distance between a user beacon device and the terminal may be calculated at predetermined periods, and only the power saving function of the monitor may be performed.

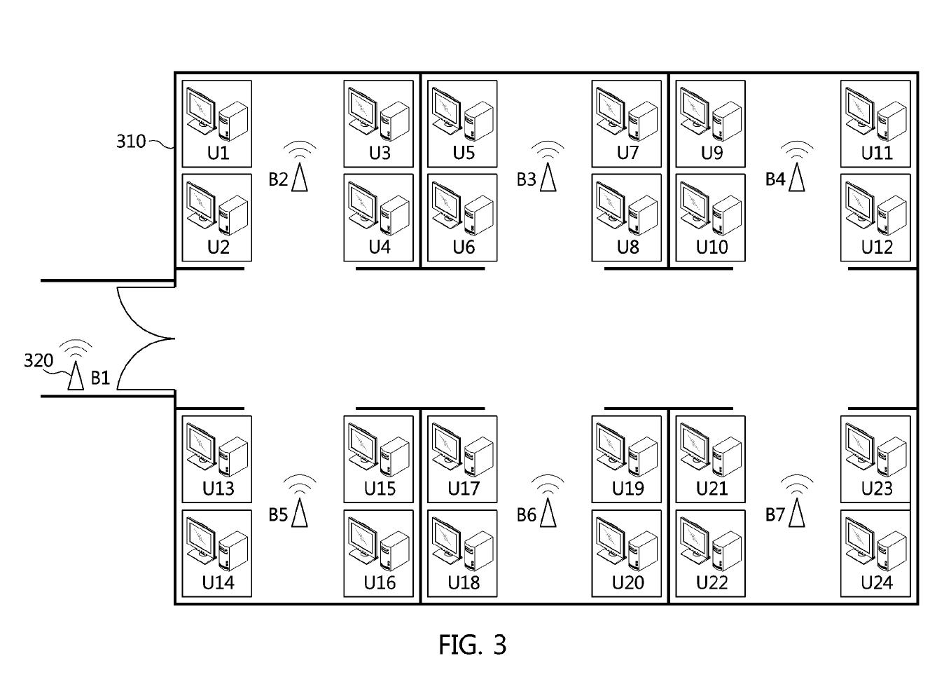

FIG. 3 is a diagram illustrating an example in which beacon devices are installed in an office environment according to an embodiment of the present invention.

Referring to FIG. 3, it can be seen that seven user beacon devices B1 to B7 are spaced apart from one another and installed in an office 310 shown in FIG. 3. In this case, one or more beacon devices may be installed outside the gate of the office 310 in order to check entry and exit states. Each of the beacon devices may be installed for each section or person by considering the radius in which the beacon device can detect signals in the office environment.

Referring to FIG. 3, B2 may be set for the users of computers at locations U1 to U4 as their user beacon device, and B3 may be set for the users of computers at locations U5 to U8 as their user beacon device. As described above, a single beacon device may be set as a user beacon device with respect to some computers. If the locations of the computers change, the user beacon devices may be set again in accordance with the changed locations.

Furthermore, if a beacon device that belongs to the beacon devices and that is closest to the terminal of a user is B1, i.e., a gate beacon device 320, an approximate distance between the gate beacon device 320 and the terminal may be calculated at predetermined periods, and whether the user is in an exit state may be determined by checking whether the beacon device that is closest to the terminal is still the gate beacon device 320. If the approximate distance between the gate beacon device 320 and the terminal has continued to increase at predetermined periods but the beacon device that is closest to the terminal has been updated with any one of the beacon devices B2 to B7 installed in the office 210, it may be determined that the user is not in an exit state, but has simply moved from the gate to an indoor direction. A various number of such beacon devices may be installed at various locations depending on the structure of the office 310 and the difference in the performance of the beacon devices.

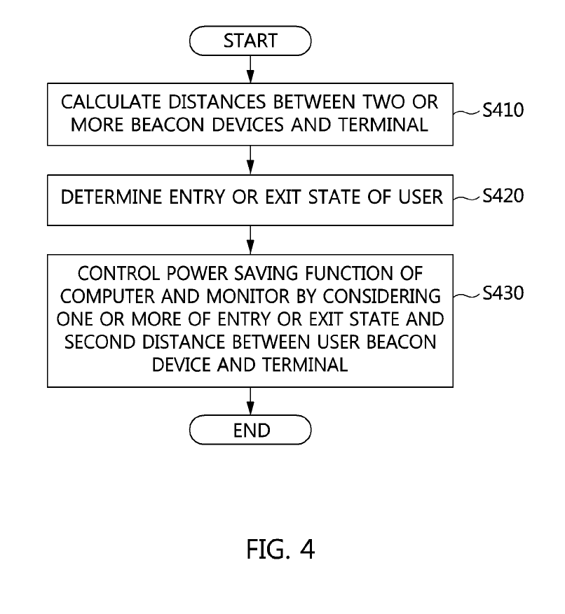

FIG. 4 is an operation flowchart illustrating a method of automatically controlling the power saving function of a computer and a monitor according to an embodiment of the present invention.

Referring to FIG. 4, in the method for automatically controlling the power saving function of a computer and a monitor according to the present embodiment, the distances between two or more beacon devices installed inside and outside a building and the terminal of a user are calculated at step S410.

Among indoor location awareness technologies, an indoor location awareness technology using a BLE-based beacon device has advantages in terms of installation and maintenance costs, an awareness distance and error, and user convenience attributable to the use of a personal mobile phone over other technologies when a common office environment is taken into account.

A plurality of beacon devices may be installed indoors so that the radio signal range of the BLE-based beacon devices can cover an overall area within a building or office. Furthermore, in order to detect the entry and exit of a user, a beacon device may also be installed at the gate of the building or office. For example, at least two beacon devices may be installed, for example, one in an office and the other at the gate of the office.

In this case, the moving direction of the terminal may be checked based on any one of a gate beacon device that belongs to the two or more beacon devices and that has been installed at the gate of the office and a user beacon device that is closest to the computer of a user. A first distance between the gate beacon device and the terminal and a second distance between the user beacon device and the terminal may each be calculated by applying an error compensation distance to an approximate distance between any one beacon device and the terminal according to the moving direction. In this case, the moving direction may be classified as the direction in which the terminal becomes distant from a beacon device set as a reference, or as the direction in which the terminal becomes close to the beacon device. The distances between the beacon device and the terminal may each be calculated by adding the error compensation distance to the approximate distance or subtracting the error compensation distance from the approximate distance according to the moving direction.

The error compensation distance may be set by a user or system developer, and may be freely modified by a user or a system developer after the error compensation distance has been set.

In this case, the approximate distance may be calculated using signal intensity information included in beacon signals transmitted by the two or more beacon devices at predetermined periods, and the moving direction may be checked by calculating the approximate distance at predetermined periods.

Using the above-described method, the moving direction may be classified as the direction in which the terminal moves out of the office, or as the direction in which the terminal moves into the office by determining the moving direction of the user based on the gate beacon device. The first distance may be calculated by adding or subtracting the error compensation distance to or from the approximate distance between the gate beacon device and the terminal according to the moving direction.

Furthermore, the signal intensity information may be information based on which the distances between the two or more beacon devices and the terminal that receives the beacon signals may be calculated as an approximate value. A distance ranging from several centimeters to tens of meters may be detected using the intensity of the beacon signals.

In this case, the signal intensity information used to calculate the first distance and the second distance may be obtained by identifying a gate beacon ID that belongs to beacon IDs, which are included in the beacon signals along with the signal intensity information and which correspond to the two or more beacon devices, and that corresponds to the gate beacon device and a user beacon ID that belongs to beacon IDs, which are included in the beacon signals along with the signal intensity information and which correspond to the two or more beacon devices, and that corresponds to the user beacon device.

Furthermore, in the method for automatically controlling the power saving function of a computer and a monitor according to the present embodiment, the entry or exit state of the user is determined by checking a change in a first distance that belongs to the distances between the two or more beacon devices and the terminal of the user and that is the distance between the terminal and a beacon device at step S420. For example, whether the user is located inside or outside the building may be checked based on the gate beacon device. Furthermore, if the user is located outside the building, whether the user moves in order to enter the building may be checked.

In this case, a beacon device that belongs to the two or more beacon devices and that is closest to the terminal of the user may be searched for by comparing the distances between the two or more beacon devices and the terminal. If the beacon device that is closest to the terminal is the gate beacon device, the entry or exit state of the user may be determined by considering one or more of whether the closest beacon device has been updated and a change in the first distance. Since the user has to pass through the gate in order to move outside the building or office, the gate beacon device may be the beacon device that is closest to the terminal of the user at the moment when the user passes through the gate. Accordingly, the time at which the user passes through the gate, i.e., the time at which the beacon device that is closest to the terminal of the user is the gate beacon device, may be detected, and the entry or exit state of the terminal may be checked by checking the moving direction of the user from the detected time.

In this case, if the first distance calculated at predetermined periods has gradually increased and the closest beacon device has not been updated in the gate beacon device, the entry or exit state of the user may be determined to be an exit state. For example, if a beacon device that is closest to the terminal of the user is detected as a gate beacon device, a first distance between the terminal and the gate beacon device may be checked at predetermined periods. In this case, if the first distance had continued to increase but the gate beacon device has not been updated in the beacon device that is closest to the terminal, the entry or exit state of the user may be determined to be the exit state in which the user has passed through the gate and has moved outdoors. Furthermore, if the first distance has continued to increase and a beacon device that is closest to the terminal has been updated with another beacon device installed indoors, the user may be determined to have passed through the gate and moved indoors or to have moved in an indoor direction near the gate.

Furthermore, in the method for automatically controlling the power saving function of a computer and a monitor according to the present embodiment, the power saving function of the computer and monitor of the user is controlled by considering one or more of the entry or exit state of the user and a second distance that belongs to the distances between the two or more beacon devices and the terminal of the user and that is the distance between the terminal and a user beacon device that belongs to the two or more beacon devices and that is closest to the computer of the user at step S430. The power saving function of the computer and monitor is performed by, for example, the steps of monitor brightness control, monitor power on/off, and computer power saving mode. If the power saving function of the monitor is to be performed, the power saving state of the computer and monitor may be checked first, and then power saving control may be performed. Furthermore, after the computer and the monitor have been run in power saving mode, the power states of the computer and monitor may be checked and managed at specific periods.

Furthermore, the control of the power saving function of the computer and monitor may be performed in such a manner that a power control request message is sent to agent software installed on the computer of the user via applications installed on the apparatus for automatically controlling the power saving function of a computer and a monitor and on the terminal and then the agent software that has received the request message controls the power saving function of the computer and monitor of the user. In this case, in order to enter power saving mode of the computer and monitor, the power saving function of the computer and the monitor may be controlled in accordance with a wake-on-LAN (WOL) method using wireless communication, such as Wi-Fi, 3G, or 4G communication. In accordance with the WOL method, a computer in power saving mode may be woken up by sending a specific packet to the computer connected to the same local area network (LAN).

In this case, if the second distance between the gate beacon device and the terminal is equal to or longer than a predetermined limit distance, the power saving function of the monitor may be performed. If the entry or exit state of the user is an exit state and the first distance between the user beacon device and the terminal is equal to or longer than a predetermined external limit distance, the power saving function of the computer may be performed. For example, the limit distance and the external limit distance may be set by a user or the apparatus 110 for automatically controlling the power saving function of a computer and a monitor. If the user becomes distant above the limit distance and the external limit distance, the power saving function of the monitor and computer may be performed. Furthermore, when the computer and the monitor are in power saving state, the user who enters within the limit distance and the external limit distance may be detected, and then a power saving may be released before the user reaches the computer.

In this case, the power saving function of the monitor may be controlled by comparing the second distance with the predetermined limit distance at predetermined periods. Whenever the beacon signals broadcast by the two or more beacon devices at predetermined periods are received by the terminal, the second distance between the user beacon device and the terminal may be calculated. Accordingly, the location of the user and whether the user has moved may be checked by comparing the second distance with the limit distance at predetermined periods, and then the power saving function of the monitor may be controlled.

Furthermore, the predetermined periods may be set by a user or a system developer. In this case, if the predetermined periods are set to be short, a system load may be increased. If the predetermined periods are set to be long, the efficiency of a power saving system may be lowered. Accordingly, a criterion for setting appropriate periods when a user set periods may be proposed by setting up a maximum period that is the longest period that can be set and a minimum period that is the shortest period that can be set.

In this case, the predetermined limit distance and the predetermined external limit distance may be set by considering one or more of the time at which the power saving function of the computer and monitor is released and average moving speed of the user. For example, the predetermined limit distance and the predetermined external limit distance may be set by calculating the distance in which the user may move during a period from the time at which the power saving function of the computer is released from power saving mode of the computer to the time at which the computer returns to a normal state using the average moving speed of the user. Furthermore, if the return period is various because the stepwise power saving modes of the computer and monitor are present, a personal power saving system may be provided to each user by differently setting the limit distance and the external limit distance depending on the type of power saving mode.

Furthermore, the average moving speed of a user may be calculated for each user based on the approximate distance calculated using the beacon signals received by the terminal at predetermined periods. For example, if the first distance between the user beacon device and the terminal changes at predetermined periods, it may be determined that a user is moving. The moving speed of the user may be calculated by calculating the period corresponding to the predetermined period and a change in the first distance that occurs at the predetermined periods.

In this case, if the power saving function of the computer is released, the power saving function of the monitor may also be released. For example, when both the computer and the monitor are in power saving state, the power saving function of the computer may be released when the user moves in the direction of the computer, and then the power saving function of the monitor may be released. However, when the computer and the monitor are sequentially released from power saving mode as described above, a system load may increase because an unnecessary operation is performed when the power saving function of the monitor is released. Accordingly, the power saving function of the computer and the power saving function of the monitor may be simultaneously released. If the user moves in the direction of the computer of the user and does not move in an area in which the power saving function of the monitor needs to be performed, a second distance between the user beacon device and the terminal may be calculated at predetermined periods, and then only the power saving function of the monitor may be performed.

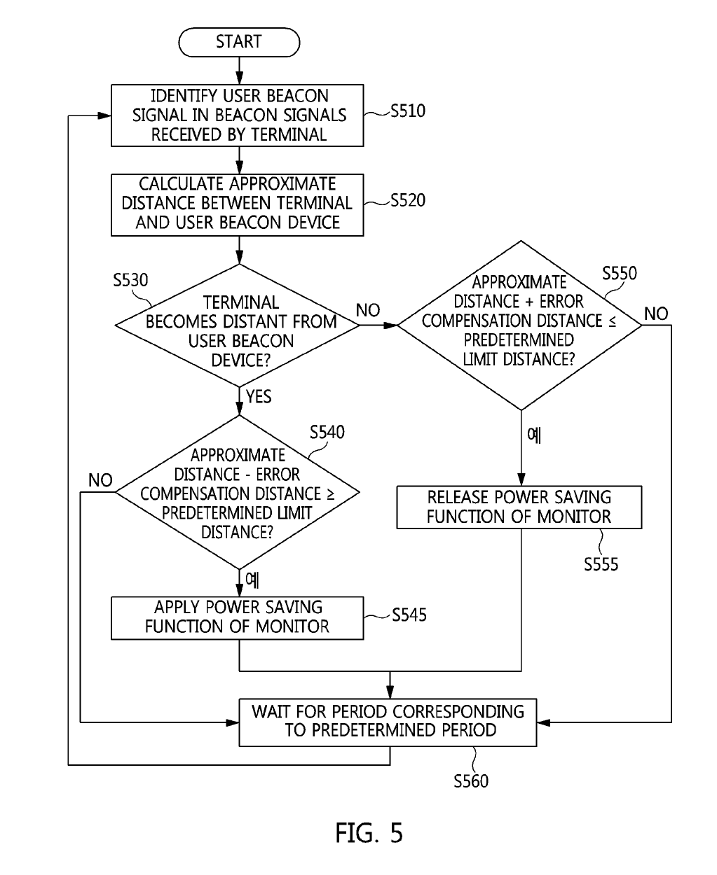

FIG. 5 is an operation flowchart illustrating a process of controlling the power saving function of a monitor according to an embodiment of the present invention.

Referring to FIG. 5, in the process of saving the power of a monitor according to the present embodiment, first, a user beacon signal is identified in beacon signals received by the terminal from the two or more beacon devices at step S510. In this case, a beacon signal corresponding to a user beacon ID of beacon IDs included in the beacon signals may be identified as the user beacon signal.

Thereafter, an approximate distance between the terminal and a user beacon device is calculated at step S520. In this case, the approximate distance may be calculated using signal intensity information that is included in the beacon signal and that has been transmitted along with the beacon ID, and may be calculated using the intensity of the beacon signal included in the signal intensity information.

Thereafter, each of the two or more beacon devices determines whether the terminal becomes distant from the user beacon device by calculating the approximate distance at predetermined periods based on the beacon signal that is broadcast at predetermined periods at step S530.

If, as a result of the determination at step S530, it is determined that the terminal becomes distant from the user beacon device, each of the two or more beacon devices determines whether a distance calculated by subtracting an error compensation distance from the calculated approximate distance is equal to or longer than a predetermined limit distance at step S540.

If, as a result of the determination at step S540, it is determined that the calculated distance is equal to or longer than the predetermined limit distance, the power saving function of the monitor of the user is performed at step S545.

Furthermore, if, as a result of the determination at step S530, it is determined that the terminal becomes close to the user beacon device, each of the two or more beacon devices determines whether a distance calculated by adding an error compensation distance to the calculated approximate distance is equal to or shorter than a predetermined limit distance at step S550.

If, as a result of the determination at step S550, it is determined that the calculated distance is equal to or shorter than the predetermined limit distance, the power saving function of the monitor of the user is released at step S555.

Furthermore, if, as a result of the determination at step S540, it is determined that the calculated distance is shorter than the predetermined limit distance or if, as a result of the determination at step S550, it is determined that the calculated distance is longer than the predetermined limit distance, each of the two or more beacon devices waits for a period corresponding to the predetermined period at step S560.

The aforementioned process may be repeatedly performed in order to continue to automatically control the power saving function of the monitor.

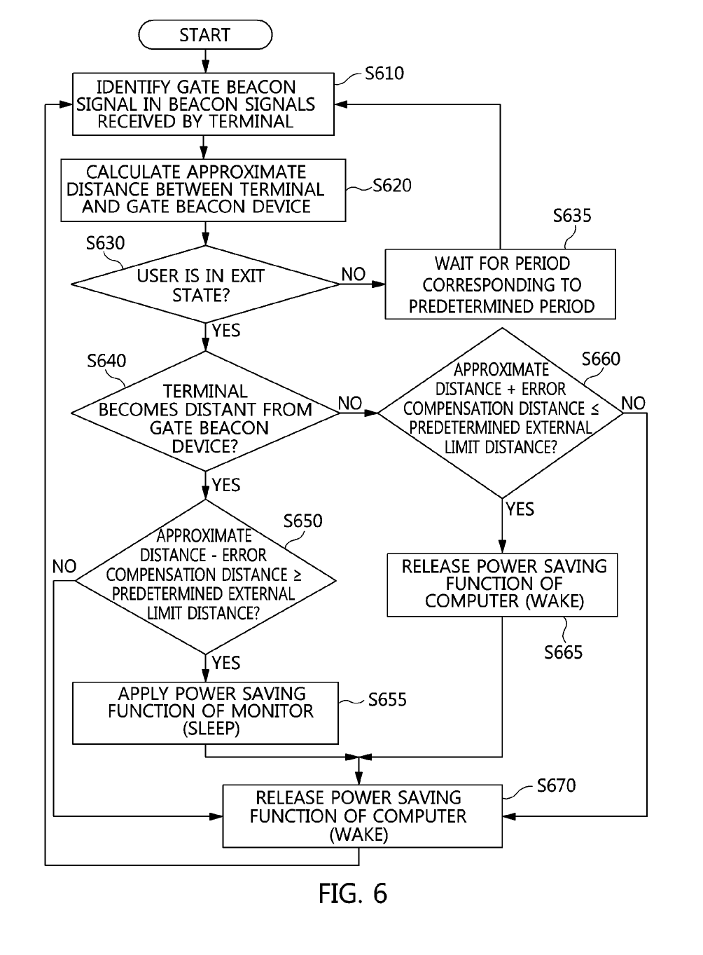

FIG. 6 is an operation flowchart illustrating a process of controlling the power saving function of a computer according to an embodiment of the present invention.

Referring to FIG. 6, in the process of controlling the power saving function of a computer according to the present embodiment, first, a gate beacon signal is identified in beacon signals received by the terminal from the two or more beacon devices at step S610. In this case, a beacon signal corresponding to a gate beacon ID of beacon IDs included in the beacon signals may be identified as the gate beacon signal.

Thereafter, an approximate distance between the terminal and a gate beacon device is calculated at step S620. In this case, the approximate distance may be calculated using signal intensity information that is included in the beacon signal and that has been transmitted along with the beacon ID, and may be calculated using the intensity of the beacon signal included in the signal intensity information.

Thereafter, whether a user is in an exit state is determined at step S630. The exit state of the user may be determined by considering a change in a first distance between the gate beacon device and the terminal and whether a beacon device that is closest to the terminal has been updated if the gate beacon device is the beacon device that is closest to the terminal.

If, as a result of the determination at step S630, it is determined that the user is in exit state, an approximate distance is calculated at predetermined periods based on the beacon signals transmitted by the two or more beacon devices at predetermined periods, and whether the terminal becomes distant from the gate beacon device is determined at step S640.

If, as a result of the determination at step S640, it is determined that the terminal becomes distant from the gate beacon device, whether a distance calculated by subtracting an error compensation distance from the calculated approximate distance is equal to or longer than a predetermined external limit distance at step S650.

If, as a result of the determination at step S650, it is determined that the calculated distance is equal to or longer than the predetermined external limit distance, the power saving function of the computer of the user is performed at step S655.

Furthermore, if, as a result of the determination at step S640, it is determined that the terminal becomes close the gate beacon device, whether a distance calculated by adding an error compensation distance to the calculated approximate distance is equal to or shorter than a predetermined external limit distance at step S660.

If, as a result of the determination at step S660, it is determined that the calculated distance is equal to or shorter than the predetermined external limit distance, the power saving function of the computer of the user is released at step S665.

Furthermore, if, as a result of the determination at step S630, it is determined that the user is not in exit state, each of the two or more beacon devices waits for a period corresponding to the predetermined period at step S635.

Furthermore, if, as a result of the determination at step S650, it is determined that the calculated distance is less than the predetermined external limit distance or if, as a result of the determination at step S660, it is determined that the calculated distance exceeds the predetermined external limit distance, each of the two or more beacon devices waits for a period corresponding to the predetermined period at step S670.

The aforementioned process may be repeatedly performed in order to continue to automatically control the power saving function of the computer.

As described above, the apparatus and method for automatically controlling the power saving function of a computer and a monitor according to the embodiments of the present invention are not limited to the configurations and methods of the aforementioned embodiments, and some or all of the embodiments may be selectively combined and configured so that the embodiments are modified in various ways.

As described above, according to at least one embodiment of the present invention, there is provided a method of detecting the location of a user in an office environment or the distance between the user and a computer of the user and automatically controlling the entry and return of the computer to and from power saving mode and the power on and off states of a monitor using the detected location or signal intensity information and information about an expected period it takes for the user computer to return to its working state.

According to at least one embodiment of the present invention, there is provided a method of automatically conserving the power of a computer and a monitor having improved user convenience, which is capable of increasing the utilization of a power saving function and thus saving power consumed as building energy.

Although the specific embodiments of the present invention have been disclosed for illustrative purposes, those skilled in the art will appreciate that various modifications, additions and substitutions are possible without departing from the scope and spirit of the invention as disclosed in the accompanying claims.

What is claimed is:

1. An apparatus for automatically controlling a power saving function of a computer and a monitor, the apparatus comprising:
a distance calculation unit configured to calculate distances between two or more beacon devices, installed within a building, and a terminal of a user;
an entry or exit determination unit configured to determine an entry or exit state of the user by checking a change in a first distance that belongs to the distances and that is a distance between the terminal and a gate beacon device that belongs to the two or more beacon devices and that is installed at a gate; and
a power saving control unit configured to control a power saving function of the computer and monitor of the user by considering one or more of the entry or exit state and a second distance that belongs to the distances and that is a distance between the terminal and a user beacon device that belongs to the two or more beacon devices and that is closest to the computer of the user.

2. The apparatus of claim 1, wherein the distance calculation unit checks a moving direction of the terminal based on any one of the gate beacon device and the user beacon device, and calculates each of the first distance and the second distance by applying an error compensation distance to an approximate distance between any one of the beacon devices and the terminal according to the moving direction.

3. The apparatus of claim 2, wherein the distance calculation unit calculates the approximate distance using signal intensity information included in beacon signals transmitted by the two or more beacon devices at predetermined periods, calculates the approximate distance at the predetermined periods, and checks the moving direction.

4. The apparatus of claim 3, wherein the distance calculation unit obtains the signal intensity information used to calculate the first distance and the second distance by identifying a gate beacon ID that belongs to beacon IDs, which are included in the beacon signals along with the signal intensity information and which correspond to the two or more beacon devices, and that corresponds to the gate beacon device and a user beacon ID that belongs to the beacon IDs and that corresponds to the user beacon device.

5. The apparatus of claim 4, wherein the entry or exit determination unit searches for a beacon device that belongs to the two or more beacon devices and that is closest to the terminal by comparing the distances, and determines the entry or exit state by considering one or more of whether the closest beacon device has been updated and the change in the first distance if the closest beacon device is the gate beacon device.

6. The apparatus of claim 5, wherein the entry or exit determination unit determines the entry or exit state to be an exit state if the first distance calculated at the predetermined period has gradually increased and the closest beacon device has not been updated in the gate beacon device.

7. The apparatus of claim 6, wherein the power saving control unit applies a power saving function of the monitor if the second distance is equal to or longer than a predetermined limit distance, and applies a power saving function of the computer if the entry or exit state is an exit state and the first distance is equal to or longer than a predetermined external limit distance.

8. The apparatus of claim 7, wherein the power saving control unit controls the power saving function of the monitor by comparing the second distance with the predetermined limit distance at the predetermined periods.

9. The apparatus of claim 8, wherein the power saving control unit sets the predetermined limit distance and the predetermined external limit distance by considering one or more of an average moving speed of the user and a period it takes for the power saving function of the computer and the monitor to be released.

10. The apparatus of claim 7, wherein the power saving control unit releases the power saving function of the monitor when the power saving control unit releases the power saving function of the computer.

11. A method of automatically controlling a power saving function of a computer and a monitor, the method comprising:
calculating distances between two or more beacon devices, installed within a building, and a terminal of a user;
determining an entry or exit state of the user by checking a change in a first distance that belongs to the distances and that is a distance between the terminal and a gate beacon device that belongs to the two or more beacon devices and that is installed at a gate; and
controlling a power saving function of the computer and monitor of the user by considering one or more of the entry or exit state and a second distance that belongs to the distances and that is a distance between the terminal and a user beacon device that belongs to the two or more beacon devices and that is closest to the computer of the user.

12. The method of claim 11, wherein calculating the distances comprises:
checking a moving direction of the terminal based on any one of the gate beacon device and the user beacon device; and
calculating each of the first distance and the second distance by applying an error compensation distance to an approximate distance between any one of the beacon devices and the terminal according to the moving direction.

13. The method of claim 12, wherein calculating the distances comprises:
calculating the approximate distance using signal intensity information included in beacon signals transmitted by the two or more beacon devices at predetermined periods;
calculating the approximate distance at the predetermined periods; and
checking the moving direction.

14. The method of claim 13, wherein calculating the distances comprises:
obtaining the signal intensity information used to calculate the first distance and the second distance by identifying a gate beacon ID that belongs to beacon IDs, which are included in the beacon signals along with the signal intensity information and which correspond to the two or more beacon devices, and that corresponds to the gate beacon device and a user beacon ID that belongs to the beacon IDs and that corresponds to the user beacon device.

15. The method of claim 14, wherein:
determining the entry or exit state comprises searching for a beacon device that belongs to the two or more beacon devices and that is closest to the terminal by comparing the distances; and
the entry or exit state is determined by considering one or more of whether the closest beacon device has been updated and the change in the first distance if the closest beacon device is the gate beacon device.

16. The method of claim 15, wherein determining the entry or exit state comprises determining the entry or exit state to be an exit state if the first distance calculated at the predetermined periods has gradually increased and the closest beacon device has not been updated in the gate beacon device.

17. The method of claim 16, wherein controlling the power saving function comprises:
applying a power saving function of the monitor if the second distance is equal to or longer than a predetermined limit distance; and
applying a power saving function of the computer if the entry or exit state is an exit state and the first distance is equal to or longer than a predetermined external limit distance.

18. The method of claim 17, wherein controlling the power saving function comprises controlling the power saving function of the monitor by comparing the second distance with the predetermined limit distance at the predetermined periods.

19. The method of claim 18, wherein controlling the power saving function comprises setting the predetermined limit distance and the predetermined external limit distance by considering one or more of an average moving speed of the user and a period it takes for the power saving function of the computer and monitor to be released.

20. The method of claim 17, wherein controlling the power saving function comprises releasing the power saving function of the monitor when the power saving control unit releases the power saving function of the computer.
